(19) United States
(12) Patent Application Publication
(10) Pub. No.: US 2012/0121232 A1
(43) Pub. Date: May 17, 2012

(54) METHOD AND APPARATUS FOR REPRODUCING DATA

(75) Inventors: Young-o PARK, Seoul (KR); Kwan-woong SONG, Seongnam-si (KR); Kwang-Pyo CHOI, Anyang-si (KR)

(73) Assignee: SAMSUNG ELECTRONICS CO., LTD., Suwon-si (KR)

(21) Appl. No.: 13/111,589

(22) Filed: May 19, 2011

(30) Foreign Application Priority Data
Nov. 11, 2010 (KR) 10-2010-0112125

(51) Int. Cl. H04N 9/80

(52) U.S. Cl. 386/241; 386/E05.003

(57) ABSTRACT

A method and apparatus for reproducing data are provided. The method and apparatus involve receiving a first signal for marking a desired reproduction position in media data; storing reproduction information for reproducing the media data from the desired reproduction position without searching for reference data in the media data; and reproducing the media data by using the reproduction information if a second signal is received so as to request the media data to be reproduced from the desired reproduction position.

### CROSS-REFERENCE TO RELATED PATENT APPLICATION

This application claims the benefit of Korean Patent Application No. 10-2010-0112125, filed on Nov. 11, 2010 in the Korean Intellectual Property Office, the disclosure of which is incorporated herein in its entirety by reference.

### BACKGROUND

1. Field

Methods and apparatuses consistent with exemplary embodiments relate to a method and apparatus for reproducing data, and more particularly, to a method and apparatus for immediately reproducing data at a reproduction position marked by a user.

2. Description of the Related Art

In the image processing field, image data is encoded and then transmitted and processed so as to increase data transmission efficiency. An image reproducing apparatus decodes the encoded image data and reproduces the image data.

The encoded image data may be classified into an I-frame, a P-frame, or a B-frame according to whether the encoded frame refers to another image frame. The I-frame may be decoded without referring to another image frame, the P-frame may be decoded by referring to a previous image frame, and the B-frame may be decoded by referring to a previous or next image frame.

In order for a user to reproduce an image at a particular position, the user has to search for the I-frame that is adjacent to a user-desired position.

### SUMMARY

One or more exemplary embodiments provide a method and apparatus for immediately reproducing data at a reproduction position marked by a user.

According to an aspect of an exemplary embodiment, there is provided a method of reproducing data, the method including receiving a first signal for marking a desired reproduction position in media data; storing reproduction information that is used to reproduce the media data from the desired reproduction position without searching for reference data in the media data; and when a second signal is received so as to request the media data to be reproduced from the desired reproduction position, reproducing the media data using the reproduction information.

The operation of storing reproduction information includes decoding an image frame in the media data; determining whether an image frame at the desired reproduction position or an image frame after the desired reproduction position refers to the decoded image frame; and if the image frame at the desired reproduction position or the image frame after the desired reproduction position refers to the decoded image frame, storing the decoded image frame.

The operation of storing the decoded image frame includes discarding the decoded image frame, if the image frame at the desired reproduction position or the image frame after the desired reproduction position does not refer to the decoded image frame.

The reproduction information may include information about the desired reproduction position, header information about the media data, and information about the decoded image frame to be referred to by the image frame at the desired reproduction position or the image frame after the desired reproduction position.

The header information may include at least one of encoding type information about the media data, setting information about a decoder for decoding the media data, type information about the image frame at the desired reproduction position or about the image frame after the desired reproduction position, and information about image frames to be referred to by the image frame at the desired reproduction position and by the image frame after the desired reproduction position, respectively.

The media data may be encoded according to the Moving Picture Experts Group-4 (MPEG-4) standard, and the header information may include at least one of a video object layer (VOL) header and a video of picture (VOP) header.

The media data may be encoded according to the H.264 standard, and the header information may include at least one of a Sequence Parameter Set (SPS) and a Picture Parameter Set (PPS).

The first signal may include a signal for requesting generation of a bookmark at the desired reproduction position, or a signal for requesting a section repeat from the desired reproduction position.

According to an aspect of another exemplary embodiment, there is provided a data reproducing apparatus including a signal receiving unit that receives a first signal for marking a desired reproduction position in media data; a control unit that controls reproduction information to be stored, wherein the reproduction information is used to reproduce the media data from the desired reproduction position without searching for reference data in the media data; and a reproduction unit that reproduces the media data by using the reproduction information, if the signal receiving unit receives a second signal used to request the media data to be reproduced from the desired reproduction position.

### BRIEF DESCRIPTION OF THE DRAWINGS

The above and other aspects will become more apparent by describing in detail exemplary embodiments with reference to the attached drawings in which:

FIG. 1 is a block diagram of a reproduction system in which media data is reproduced, according to an exemplary embodiment;

FIG. 2 is a block diagram of a data reproducing apparatus according to an exemplary embodiment;

FIG. 3 illustrates an example of a procedure in which the data reproducing apparatus reproduces image data according to an exemplary embodiment;

FIG. 4 illustrates a hierarchical structure of H.264 image data according to an exemplary embodiment;

FIG. 5 illustrates a hierarchical structure of MPEG-2 image data according to an exemplary embodiment;

FIG. 6 illustrates a hierarchical structure of MPEG-4 image data according to another embodiment of the present invention;

FIG. 7 is a flowchart of a method of reproducing data, according to an exemplary embodiment; and

FIG. 8 is a flowchart for describing in detail a procedure in operation s720 of FIG. 7.

### DETAILED DESCRIPTION OF EXEMPLARY EMBODIMENTS

Hereinafter, exemplary embodiments will be described in detail with reference to the attached drawings.

FIG. 1 is a block diagram of a reproduction system in which media data is reproduced, according to an exemplary embodiment.

The reproduction system according to an exemplary embodiment includes an application layer 110, a framework layer 120, and an element description layer 130.

The application layer 110 provides an interface with a user. The application layer 110 receives a user input, and delivers a command corresponding to the user input to the framework layer 120.

The framework layer 120 manages a reproduction status of the media data according to the command from the application layer 110, and controls the element description layer 130. The framework layer 120 may be referred to as a player engine layer. A platform used to implement the framework layer 120 may vary according to operating systems (OSs). For example, a ‘DirectShow’ platform is used in a Windows-based OS, a ‘GStreamer’ platform is used in a Linux-based OS, and an ‘OpenCore’ platform is used in an Android-based OS.

The element description layer 130 includes one or more modules that perform a predetermined operation according to a control signal of the framework layer 120. Each of the modules may be implemented as hardware or software, or may be implemented with both hardware and software. A parser, an encoder, a decoder, a renderer, or the like are examples of the modules that may be included in the element description layer 130.

Hereinafter, operations of the reproduction system are described with respect to i) a case in which a user normally requests reproduction of media data, and ii) a case in which a user requests setting of a bookmark.

In the case in which a user normally requests reproduction of media data, the application layer 110 receives a request for reproduction of media data from a user. The user may request the reproduction of the media data in a manner that the user drives an application, selects desired media data, and then presses a play button.

The application layer 110 delivers a command corresponding to the reproduction request to the framework layer 120. For example, a command such as API(PLAY) may be delivered to the framework layer 120. Various types of previously-agreed protocols (e.g., the Session Initiation Protocol (SIP), the Hypertext Transfer Protocol (HTTP), the Real-time Transport Protocol (RTP), or the like) may be used between the application layer 110 and the framework layer 120.

The framework layer 120 interprets API(PLAY), and controls the parser, the decoder, and the renderer so as to control the media data to be reproduced.

ii) a case in which a user requests setting of a bookmark

In the case in which a user requests setting of a bookmark, the application layer 110 receives a request for setting of a bookmark from a user. In general, the user sets the bookmark at a desired position while media data is reproduced, but it is not required that the user to set the bookmark while the media data is reproduced.

When the application layer 110 delivers a command corresponding to the bookmark setting request to the framework layer 120, the framework layer 120 controls the element description layer 130 so as to store information about a position at which the bookmark is set, and to store information that is used to reproduce the media data from a reproduction position at which the bookmark is set.

According to the control by the framework layer 120, the parser and the decoder store header information about the position at which the bookmark is set, and decode and store image data to be referred to by an image frame of the position at which the bookmark is set.

After the bookmark is set, if the user selects the bookmarkthe application layer 110 delivers a command corresponding to reproduction at the bookmark to the framework layer 120. The reproduction command may include identification information with respect to the bookmark, or bookmark position information.

The framework layer 120 controls the element description layer 130 so as to allow the image frame of the position at which the bookmark is set, to be immediately decoded by using stored information. Afterward, the media data is sequentially reproduced from the image frame of the position at which the bookmark is set.

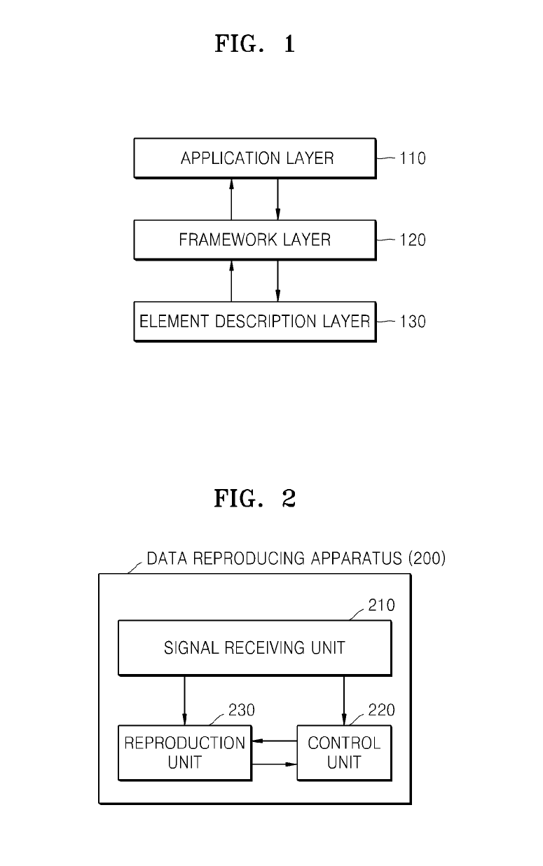

FIG. 2 is a block diagram of a data reproducing apparatus 200 according to an exemplary embodiment.

The data reproducing apparatus 200 includes a signal receiving unit 210, a control unit 220, and a reproduction unit 230.

The signal receiving unit 210 receives a signal from a user. Hereinafter, for convenience of description, a first signal indicates a signal for marking a desired reproduction position including a bookmark or repetitive reproduction, and a second signal indicates a signal for requesting reproduction to start at a marked reproduction position.

When the signal receiving unit 210 receives the first signal, the control unit 220 controls a database (not shown) to store reproduction information that is used to reproduce media data at the marked reproduction position.

When data is encoded, the compression rate can be increased by encoding only a relationship between previous data and next data. Thus, in order to decode the next data, the previous data is decoded first. However, in order to support a random access function, certain data to be decoded without using previous data is inserted into the media data, and according to an exemplary embodiment, the data to be decoded without using previously decoded data is referred to as reference data. An example of the reference data includes an I-frame of the MPEG-2, or an IDR frame of H.264.

In order to reproduce data at a user-desired reproduction position in encoded media data, adjacent reference data is searched for and then data is sequentially decoded from the reference data. Thus, the data at the user-desired reproduction position is the reference data, or previous data to be referred to is already decoded. If the data at the user-desired reproduction position is not the reference data, a delay may occur due to searching for reference data and decoding from the reference data.

In order to allow the data at the user-desired reproduction position to be immediately reproduced, the reproduction information includes at least one decoded previous data that precedes the user-desired reproduction position.

For convenience of description, it is assumed that the media data is image data. According to an image data encoding method, the number of pieces of data included in the reproduction information may vary. If all frames, except for a reference frame, refer to only a previous frame, the reproduction information includes data obtained by decoding an image frame that is positioned just before an image frame corresponding to a reproduction position. On the other hand, if all frames, except for a reference frame, refer to two previous frames, the reproduction information includes data obtained by decoding two image frames that are positioned before an image frame corresponding to a reproduction position. The reproduction information includes header information about the media data. In particular, the reproduction information includes header information related to data of the user-desired reproduction position.

The header information includes information used to set a decoding unit. For example, the information may include an encoding method, a structure of media data, an image size, a structure of an image frame, a type of an image frame, and a number of frames and identification information to be referred to by each frame.

The control unit 220 may include a decoding unit (not shown), a determining unit (not shown), and a database (not shown).

The decoding unit decodes the media data. The decoding unit decodes data within a predetermined distance from the user-desired reproduction position. However, in a case where the data within the predetermined distance from the user-desired reproduction position is already decoded and stored in a buffer, e.g., a case in which a bookmark has been set to data that is previous to data that is currently reproduced and marked by a user during reproduction of media data, the data stored in the buffer may be used without a separate decoding procedure.

The determining unit determines whether an image frame at the user-desired reproduction position or an image frame after the user-desired reproduction position refers to the decoded image frame. If the image frame at the user-desired reproduction position or the image frame after the user-desired reproduction position refers to the decoded image frame, the decoded image frame is stored in the database. However, if the image frame at the user-desired reproduction position or the image frame after the user-desired reproduction position does not refer to the decoded image frame, the decoded image frame is discarded.

When the signal receiving unit 210 receives the second signal (i.e., a signal for requesting reproduction to start at a position marked by the first signal), the reproduction unit 230 reproduces the media data by using the stored reproduction information.

Hereinafter, operations of the data reproducing apparatus 200 according to time will now be described. For convenience of description, it is assumed that media data is image data encoded according to the MPEG-2 standard, and a first signal is a signal for generating a bookmark in the image data.

A user designates the bookmark at a specific position in the image data. When the user designates the bookmark, the signal receiving unit 210 receives the first signal.

When the signal receiving unit 210 receives the first signal, the control unit 220 controls data to be previously stored, wherein the data is used to immediately reproduce image data from an image frame corresponding to the bookmark. The database stores decoded data of an image frame to be referred to by the image frame corresponding to the bookmark. If image frames after the bookmark refer to an image frame before the bookmark, the database also stores decoded data with respect to the image frame before the bookmark. Also, the database stores header information related to the image frame corresponding to the bookmark.

Afterward, the user selects the bookmark. When the user selects the bookmark, the signal receiving unit 210 receives a second signal.

When the signal receiving unit 210 receives the second signal, the control unit 220 reproduces the image data from the image frame corresponding to the bookmark by using stored information.

In more detail, the control unit 220 sets an environment of a decoding unit by using the header information stored in the database, and checks the type of the image frame corresponding to the bookmark. If the image frame corresponding to the bookmark is an I-frame, the image frame may be decoded without referring to another image frame. On the other hand, if the image frame corresponding to the bookmark is not the I-frame, the control unit 220 checks an image frame to be referred to, by using the header information stored in the database. The image frame to be referred to by the image frame corresponding to the bookmark is decoded and stored in the database.

When the image frame corresponding to the bookmark is decoded, a next image frame is decoded by using the decoded data. If the next image frame refers to an image frame other than the bookmark, decoded data with respect to the referred image frame is also stored in the database.

In other words, the data reproducing apparatus 200 according to an exemplary embodiment previously stores information used to immediately reproduce media data from a user-desired reproduction position, and uses stored data, so that the data reproducing apparatus 200 may reproduce the media data from the user-desired reproduction position without a delay. By doing so, when the user sets the bookmark, the reproducing apparatus 200 does not need to search for reference data before the bookmark. The reproducing apparatus 200 may reduce the delay associated with decoding the data between the reference data and the data at the user-desired position, especially if the distance between the reference data and the data at the user-desired position is large.

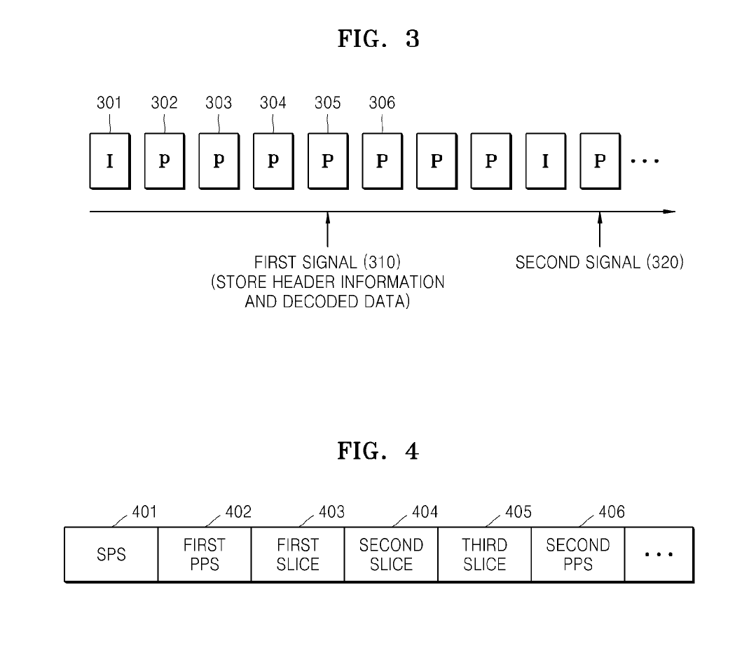

FIG. 3 illustrates an example of a procedure in which the data reproducing apparatus 200 reproduces image data.

Referring to FIG. 3, the image data includes I-frames and P-frames, wherein each I-frame is a reference frame that may be decoded without referring to another image frame. It is assumed that each P-frame is decoded by referring to two previous image frames that are positioned just ahead of each P-frame.

A user sets a bookmark at a fifth frame 305 while the image data is reproduced. When the user sets the bookmark at the fifth frame 305, the control unit 220 controls data to be stored that is used to immediately reproduce the image data from the fifth frame 305.

First, header information related to the fifth frame 305 is stored in the database. For example, the database stores sequence header information about a sequence including the fifth frame 305, a Group of Pictures (GOP) header information about a GOP including the fifth frame 305, and a frame header information about the fifth frame 305.

Also, decoded data of image frames to be referred to by the fifth frame 305, or by a frame after the fifth frame 305, is stored in the database. The fifth frame 305 refers to a third frame 303 and a fourth frame 304. Thus, decoded data with respect to the third frame 303 and the fourth frame 304 is stored. Similarly, a sixth frame 306 refers to the fourth frame 304 and the fifth frame 305. However, since the decoded data with respect to the fourth frame 304 is already stored, it is not necessary to additionally store it.

While the user watches an image, the user requests reproduction of the fifth frame 305 at which the bookmark is set.

The reproduction unit 230 obtains the stored header information and then checks that the fifth frame 305 refers to the third frame 303 and the fourth frame 304.

The reproduction unit 230 obtains the decoded data with respect to the third frame 303 and the fourth frame 304, and then decodes the fifth frame 305 by using the decoded data.

The reproduction unit 230 decodes the sixth frame 306 by using the decoded data with respect to the fourth frame 304, and the decoded data with respect to the fifth frame 305.

According to the related art, when reproduction of data at a bookmark is requested, a first frame 301 that is a reference frame is searched for. When the first frame 301 is searched for, the fifth frame 305 that is desired by the user can be reproduced only after the first frame 301 through the fourth frame 304 are decoded. Thus, a delay occurs until an image frame at a user-desired position is reproduced.

However, according to an exemplary embodiment, the image frame at the user-desired position may be immediately reproduced by using stored data, so that a delay does not occur.

FIG. 4 illustrates a hierarchical structure of H.264 image data according to an exemplary embodiment.

Image data according to the H.264 standard has a hierarchical structure formed of a sequence layer, a picture layer, and a slice layer.

A sequence according to the H.264 standard includes one or more pictures, and each picture includes one or more slices, such as first slice 403, second slice 404, and third slice 405.

A Sequence Parameter Set (SPS) 401 includes header information about the sequence.

First and second Picture Parameter Sets (PPSs) 402 and 406 include header information about a picture.

Reproduction information may include at least one of a PPS and a SPS with respect to a current picture. A picture according to the H.264 standard may include different types of slices (e.g., an I-slice, a P-slice, or the like). Thus, in order to reproduce the image data from a user-desired position, header information about a slice may be further necessary, and in this case, the header information about the slice is included in the reproduction information.

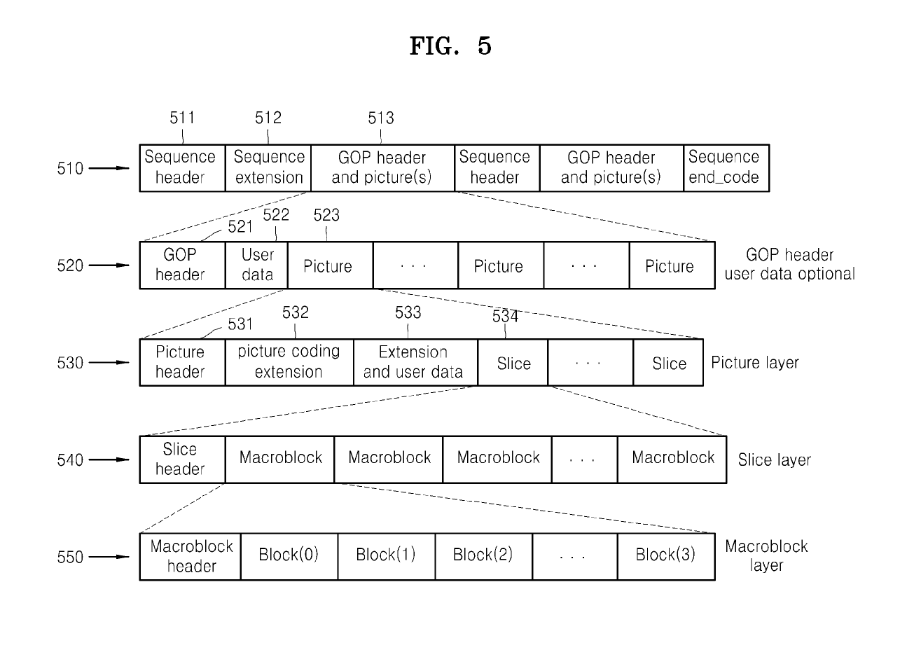

FIG. 5 illustrates a hierarchical structure of MPEG-2 image data according to an exemplary embodiment.

Image data according to the MPEG-2 standard has a hierarchical structure formed of a sequence layer 510, a GOP layer 520, a picture layer 530, a slice layer 540, and a macroblock layer 550.

The sequence layer 510 includes a sequence header 511, a sequence extension 512, and GOP data 513.

The GOP layer 520 includes a GOP header 521, user data 522, and picture data 523.

The picture layer 530 includes a picture header 531, a picture coding extension 532, user data 533, and slice data 534.

Reproduction information may include at least one of the picture header 531 including a current picture, the GOP header 521, and the sequence header 511. According to an exemplary embodiment, the reproduction information includes only some of data included in the header.

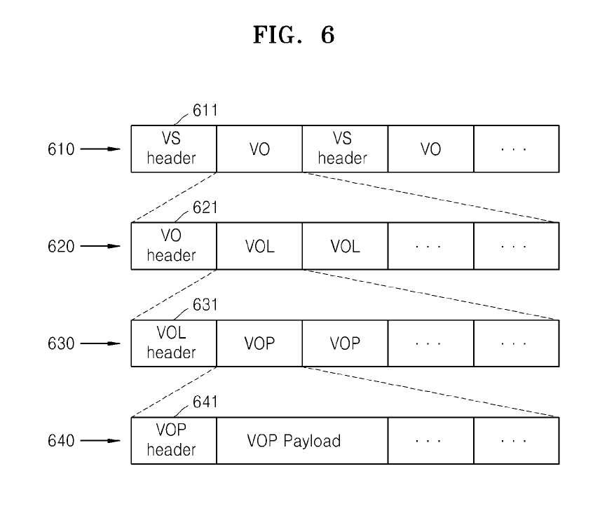

FIG. 6 illustrates a hierarchical structure of MPEG-4 image data according to an exemplary embodiment.

Image data according to the MPEG-4 standard has a hierarchical structure formed of a visual object sequence layer (hereinafter, referred to as ‘VS layer’) 610, a visual object (VO) layer 620, a video object layer (VOL) layer 630, and a video of picture (VOP) layer 640.

The VS layer 610 includes a VS header 611 and a payload area including at least one VO layer 620.

The VO layer 620 includes a VO header 621 and a payload area including at least one VOL layer 630.

The VOL layer 630 includes a VOL header 631 and a payload area including at least one VOP layer 640.

The VOP layer 640 includes a VOP header 641 and at least one VOP payload area. Data corresponding to a frame (or a picture) according to the MPEG-2 standard is stored in the VOP payload area.

Reproduction information may include at least one of the VOP header 641 including a current VOP, the VOL header 631, the VO header 621, and the VS header 611.

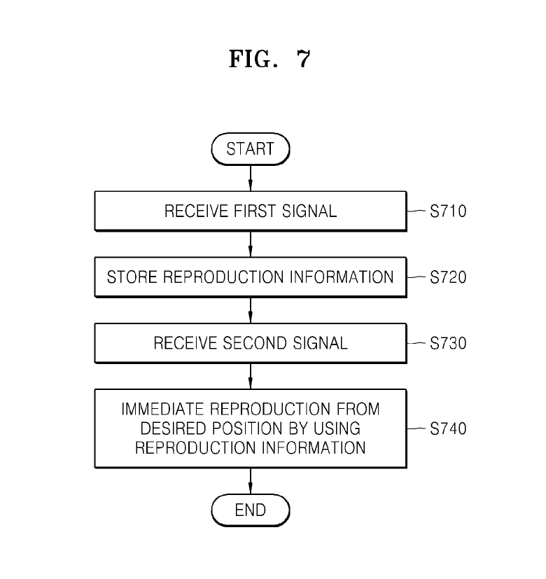

FIG. 7 is a flowchart of a method of reproducing data, according to an exemplary embodiment.

In operation s710, a first signal is received. By using the first signal, a user previously marks a desired reproduction position within media data, and the first signal includes a bookmark request signal, or a request signal for setting of a section repeat.

In operation s720, reproduction information that is used to immediately reproduce the media data from the marked desired reproduction position is stored. According to an exemplary embodiment, immediately reproducing the media data includes reproducing the media data from the marked desired reproduction position without searching for reference data in the media data.

The reproduction information may include header information related to the marked desired reproduction position, and decoded data with respect to at least one image frame preceding the marked desired reproduction position.

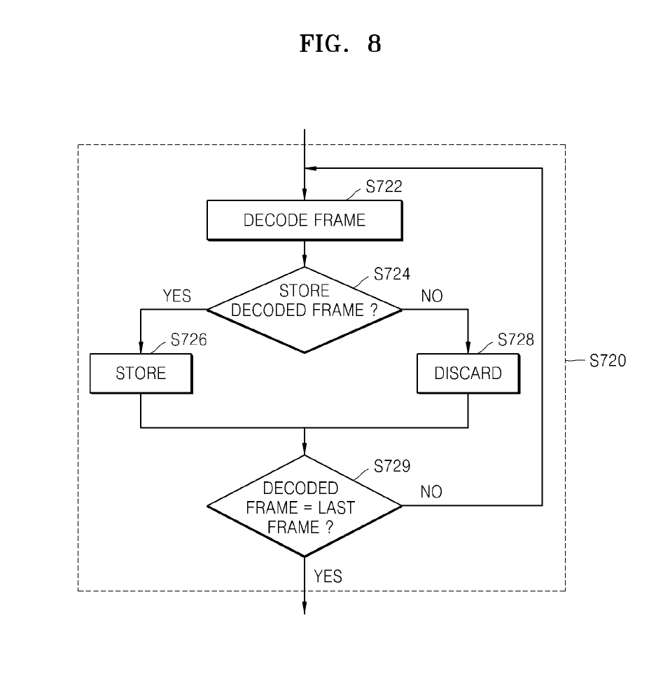

A detailed description about operation s720 will be provided later in relation to FIG. 8.

In operation s730, a second signal is received. The second signal requests the media data to be reproduced from the desired reproduction position that is marked in operation s710.

In operation S740, the media data is reproduced by using the stored reproduction information.

FIG. 8 is a flowchart for describing in detail a procedure in operation s720 of FIG. 7.

In operation s722, an image frame in the media data is decoded.

Hereinafter, operation s722 is described in detail according to three cases.

In the case where a user sets a bookmark while the media data is not reproduced, it is possible to sequentially decodes image frames from an image frame that is positioned ahead of the image frame that corresponds to the bookmark, by a predetermined number of image frames in s722. The predetermined number may be previously set by the user, may be automatically set according to a hardware (or software) environment without an input from the user, or may be adaptively set by using header information.

If a user sets a bookmark at an image frame positioned after an image frame that is currently reproduced while the user reproduces media data, in operation s722, image frames are sequentially decoded from the image frame that is currently reproduced. In a case where the user stops reproduction of the media data, it is possible to sequentially decode image frames from an image frame that is positioned ahead of the image frame that corresponds to the bookmark, by a predetermined number of image frames.

In this case, operations s724 through s729 may not be performed until the image frames are decoded from the image frame that is positioned ahead of the image frame that corresponds to the bookmark, by a predetermined number of image frames.

If a user sets a bookmark at an image frame positioned ahead of an image frame that is currently reproduced while the user reproduces media data, in operation s722, image frames are sequentially decoded from an image frame that is positioned ahead of the image frame that corresponds to the bookmark, by a predetermined number of image frames. According to one or more exemplary embodiments, the image frame that is positioned ahead of the image frame corresponding to the bookmark by a predetermined number of image frames may be decoded and stored in a buffer, and in this case, operation s722 may be omitted.

In operation s724, it is determined whether an image frame at a reproduction position, or an image frame after the reproduction position refers to the decoded image frame. If the image frame at the reproduction position, or the image frame after the reproduction position refers to the decoded image frame, operation s726 is performed so as to store the decoded image frame, otherwise, operation s728 is performed so as to discard the decoded image frame.

In operation s729, it is determined whether the decoded image frame is the image frame at the reproduction position, or whether the image frame after the reproduction position is a last image frame that is to refer to the decoded image frame. If the decoded image frame is the image frame at the reproduction position, or if the image frame after the reproduction position is the last image frame to refer to the decoded image frame, the decoded image frame is not stored any more.

The exemplary embodiments can be embodied as computer programs and can be implemented in general-use digital computers that execute the programs using a non-transitory computer-readable recording medium. Examples of the non-transitory computer-readable recording medium include magnetic storage media (e.g., ROM, floppy disks, hard disks, etc.), optical recording media (e.g., CD-ROMs, or DVDs), etc.

While exemplary embodiments have been particularly shown and described, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the inventive concept is defined not by the detailed description of the invention but by the appended claims, and all differences within the scope will be construed as being included in the inventive concept.

What is claimed is:

1. A method of reproducing data, the method comprising:
receiving a first signal that marks a desired reproduction position within media data;
storing reproduction information for reproducing the media data from the desired reproduction position without searching for reference data in the media data; and
reproducing the media data by using the reproduction information, if a second signal is received that requests the media data to be reproduced from the desired reproduction position.

2. The method of claim 1, wherein the storing the reproduction information comprises:
decoding a first image frame in the media data;
determining whether a second image frame at the desired reproduction position or a third image frame after the desired reproduction position refers to the decoded first image frame; and
if the second image frame at the desired reproduction position or the third image frame after the desired reproduction position refers to the decoded first image frame, storing the decoded first image frame.

3. The method of claim 2, further comprising discarding the decoded first image frame, if the second image frame at the desired reproduction position or the third image frame after the desired reproduction position does not refer to the decoded first image frame.

4. The method of claim 1, wherein the reproduction information comprises at least one of information about the desired reproduction position, header information about the media data, and information about the decoded first image frame to be referred to by the second image frame at the desired reproduction position or the third image frame after the desired reproduction position.

5. The method of claim 4, wherein the header information comprises at least one of encoding type information about the media data, setting information about a decoder for decoding the media data, type information about the second image frame at the desired reproduction position or about the third image frame after the desired reproduction position, and information about image frames to be referred to by the second image frame at the desired reproduction position and by the third image frame after the desired reproduction position, respectively.

6. The method of claim 4, wherein the media data is encoded according to the Moving Picture Experts Group-4 (MPEG-4) standard, and
the header information comprises at least one of a video object layer header and a video of picture header.

7. The method of claim 4, wherein the media data is encoded according to the H.264 standard, and
the header information comprises at least one of a Sequence Parameter Set and a Picture Parameter Set.

8. The method of claim 1, wherein the first signal comprises a signal that requests generation of a bookmark at the desired reproduction position, or a signal that requests a section repeat from the desired reproduction position.

9. A data reproducing apparatus comprising:
a signal receiving unit that receives a first signal marking a desired reproduction position in media data;
a control unit that controls reproduction information to be stored, wherein the reproduction information is used to reproduce the media data from the desired reproduction position without searching for reference data in the media data; and
a reproduction unit that reproduces the media data by using the reproduction information if the signal receiving unit receives a second signal requesting the media data to be reproduced from the desired reproduction position.

10. The data reproducing apparatus of claim 9, wherein the control unit comprises:
a decoding unit that decodes a first image frame in the media data;
a determining unit that determines whether a second image frame at the desired reproduction position or a third image frame after the desired reproduction position refers to the decoded first image frame; and
a storage unit that stores the decoded first image frame if the second image frame at the desired reproduction position or the third image frame after the desired reproduction position refers to the decoded first image frame.

11. The data reproducing apparatus of claim 10, wherein the control unit discards the decoded first image frame if the second image frame at the desired reproduction position or the third image frame after the desired reproduction position does not refer to the decoded first image frame.

12. The data reproducing apparatus of claim 9, wherein the reproduction information comprises at least one of header information about the media data, and decoded data with respect to the first image frame to be referred to by the second image frame at the desired reproduction position or the third image frame after the desired reproduction position.

13. The data reproducing apparatus of claim 12, wherein the header information comprises at least one of encoding type information about the media data, setting information about a decoding unit for decoding the media data, type information about the second image frame at the desired reproduction position or about the third image frame after the desired reproduction position, and information about image frames to be referred to by the second image frame at the desired reproduction position and by the third image frame after the desired reproduction position, respectively.

14. The data reproducing apparatus of claim 12, wherein the media data is encoded according to the Moving Picture Experts Group-4 standard, and
the header information comprises at least one of a video object layer header and a video of picture header.

15. The data reproducing apparatus of claim 12, wherein the media data is encoded according to the H.264 standard, and the header information comprises at least one of a Sequence Parameter Set and a Picture Parameter Set.

16. The data reproducing apparatus of claim 9, wherein the first signal comprises a signal requesting generation of a bookmark at the desired reproduction position, or a signal requesting a section repeat from the desired reproduction position.

17. A computer-readable recording medium having recorded thereon a program for executing a method comprising:
receiving a first signal that marks a desired reproduction position within media data;
storing reproduction information that is used to reproduce the media data from the desired reproduction position without searching for reference data in the media data; and
reproducing the media data by using the reproduction information if a second signal is received that requests the media data to be reproduced from the desired reproduction position.
